(19) United States
(12) Patent Application Publication
(10) Pub. No.: US 2025/0028976 A1
(43) Pub. Date: Jan. 23, 2025

(54) METHOD AND APPARATUS FOR ENTITY ALIGNMENT

(71) Applicants: Robert Bosch GmbH, Stuttgart (DE); TSINGHUA UNIVERSITY, Beijing (CN)

(72) Inventors: Xiao Liu, Beijing (CN); Evgeny Kharlamov, Muenchen (DE); Jie Tang, Beijing (CN)

(21) Appl. No.: 18/711,327

(22) PCT Filed: Dec. 24, 2021
(86) PCT No.: PCT/CN2021/141124

§ 371 Date: May 17, 2024

(51) Int. Cl. G06N 5/02

(52) U.S. Cl. CPC G06N 5/02

(57) ABSTRACT

A computer-implemented method for entity alignment. The computer-implemented method includes: obtaining a first plurality of initial embeddings of entities of a first graph and a second plurality of initial embeddings of entities of a second graph based on a pre-trained model, wherein the first plurality of initial embeddings and the second plurality of initial embeddings are in a unified space; and learning entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

### FIELD

Aspects of the present invention relate generally to artificial intelligence, and more particularly, to a method and an apparatus for entity alignment across different knowledge graphs.

### BACKGROUND INFORMATION

Knowledge graphs (KGs) have been adopted widely in various Web applications, such as search, recommendation, and question answering and the like. Constructing large-scale KGs has been a challenging tack. While new facts can be extracted from scratch, aligning existing incomplete KGs to complement each other is practically necessary, which involves entity alignment, also referred to as ontology mapping, schema matching, or entity linking. Entity alignment aims to identify equivalent entities across different KGs and plays a fundamental role in KG construction and fusion.

Recently, deep representation learning-based alignment methods have emerged as the mainstream solutions to entity alignment, where the key idea is to learn vector representations (i.e., embeddings) of KGs and identify entity alignment according to the similarity of the embeddings. However, these methods rely heavily on the supervision signals provided by human labeling, which can be biased and arduously expensive to obtain for Web-scale KGs.

Therefore, it may be desirable to develop a label-efficient method for entity alignment.

### SUMMARY

The following presents a simplified summary of one or more aspects according to the present invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the present invention, a computer-implemented method for entity alignment is provided. According to an example embodiment of the present invention, the method includes: obtaining a first plurality of initial embeddings of entities of a first graph and a second plurality of initial embeddings of entities of a second graph based on a pre-trained model, wherein the first plurality of initial embeddings and the second plurality of initial embeddings are in a unified space; and learning entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

In another aspect of the present invention, a computer-implemented method for entity alignment of graphs with natural languages is provided. According to an example embodiment of the present invention, the method includes: obtaining a first plurality of initial embeddings of entities of a first graph and a second plurality of initial embeddings of entities of a second graph based on a pre-trained language model, wherein the first graph and the second graph comprise same or different languages, and the first plurality of initial embeddings and the second plurality of initial embeddings are in a unified space; and learning entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

In another aspect of the present invention, an apparatus for entity alignment comprising a memory and at least one processor is provided. According to an example embodiment of the present invention, the at least one processor may be configured for obtaining a first plurality of initial embeddings of entities of a first graph and a second plurality of initial embeddings of entities of a second graph based on a pre-trained model, wherein the first plurality of initial embeddings and the second plurality of initial embeddings are in a unified space; and learning entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

In another aspect of the present invention, a computer program product for entity alignment comprising processor executable computer code is provided. According to an example embodiment of the present invention, the executable computer code may be executed to obtain a first plurality of initial embeddings of entities of a first graph and a second plurality of initial embeddings of entities of a second graph based on a pre-trained model, wherein the first plurality of initial embeddings and the second plurality of initial embeddings are in a unified space; and to learn entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

In another aspect of the present invention, a computer readable medium storing computer code for entity alignment is provided. According to an example embodiment of the present invention, the computer code when executed by a processor may cause the processor to obtain a first plurality of initial embeddings of entities of a first graph and a second plurality of initial embeddings of entities of a second graph based on a pre-trained model, wherein the first plurality of initial embeddings and the second plurality of initial embeddings are in a unified space; and to learn entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

By only pushing negatives far away and conducting a self negative sampling, the provided method and apparatus and the like herein according to the present invention may implement a relative proximity of the aligned ones but without any label or supervision.

Other aspects or variations of the present invention, as well as other advantages thereof will become apparent by consideration of the following detailed description and figures.

### BRIEF DESCRIPTION OF THE DRAWINGS

The disclosed aspects of the present invention will hereinafter be described in connection with the figures that are provided to illustrate and not to limit the disclosed aspects.

FIG. 1 illustrates exemplary knowledge graphs.

FIG. 2 illustrates an example of uni-space learning according to one or more aspects of the present invention.

FIG. 3 illustrates a schematic diagram of only pushing the negatives far away according to one or more aspects of the present invention.

FIG. 4 illustrates a schematic diagram of the self negative sampling according to one or more aspects of the present invention.

FIG. 5 illustrates a method of entity alignment without supervision according to one or more aspects of the present invention.

FIG. 6 illustrates another method of entity alignment without supervision according to one or more aspects of the present invention.

FIG. 7 illustrates an exemplary framework in which the one or more methods proposed herein may be embodied, according to the present invention.

FIG. 8 illustrates a schematic diagram for training depending on a negative queue for each KG to provide massive negative samples, according to an example embodiment of the present invention.

FIG. 9 illustrates an example of a hardware implementation for an apparatus for entity alignment according to one or more aspects of the present invention.

### DETAILED DESCRIPTION OF EXAMPLE EMBODIMENTS

The present invention will now be discussed with reference to several example implementations. It is to be understood that these implementations are discussed only for enabling those skilled in the art to better understand and thus implement the embodiments of the present invention, rather than suggesting any limitations on the scope of the present invention.

The present disclosure describes a method and/or a system, implemented as computer programs executed on one or more computers, which may provide a neural network configured to perform a particular machine learning task. As an example, the particular machine learning task may be a machine learning task for visual image processing. As another example, the particular machine learning task may be a machine learning task for natural language processing. As another example, the particular machine learning task may be automatic speech recognition. As another example, the particular task can be a health prediction task. As another example, the particular task can be an agent control task carried out in a control system for automatic driving, a control system for an industrial facility, or the like.

Before the deep representation learning era, most entity alignment approaches focus on handcrafted proper similarity factors and Bayesian-based probability estimation. Deep embedding-based entity alignment methods are superior in terms of flexibility and effectiveness. Generally, most deep embedding-based entity alignment methods are based on supervised or semi-supervised learning. First, entities in different KGs, especially for the multi-lingual ones, lie in different data spaces, while entity alignment needs to be projected to the same embedding space, which usually requires supervision. Second, pulling aligned entities closer in the embedding space generally needs knowing the anchors. Finally, knowing aligned entities would guarantee that aligned ones are not accidentally sampled as negatives, and thus avoiding spoiling the training. However, supervised methods' dependence on labels hinders their application in real web-scale noisy data.

The present disclosure proposes a method of entity alignment across different KGs without labels. In aspects of the disclosure, the proposed method is a self-supervised entity alignment approach. In one or more aspects of the present disclosure, some strategies or improvements are presented to get rid of supervision for entity alignment. In one aspect of the present disclosure, a uni-space learning is leveraged for projecting entities from different graphs into the same embedding space. For example, the uni-space learning may be based on a pre-trained model. In another aspect of the present disclosure, a concept of relative similarity metric (RSM) may be used. For example, instead of directly pulling the aligned targets closer in the embedding space, RSM may push non-aligned negatives far away enough. In still another aspect of the present disclosure, to avoid accidental false-negative samples, negative samples may be sampled from the source KG rather than from the target KG. These strategies or improvements may enable the proposed method of entity alignment without supervision to achieve comparable results with state-of-the-art supervised baselines.

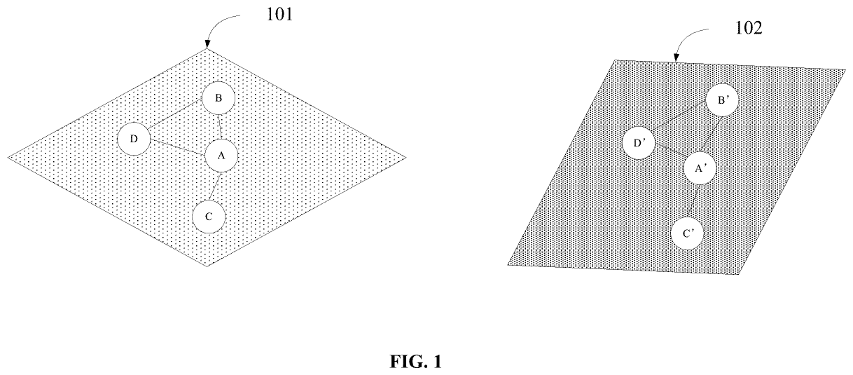

FIG. 1 illustrates exemplary knowledge graphs 101 and 102, where graph 101 comprises entities A, B, C, D, and graph 102 comprises entities A′, B′, C′, D′. For example, the graph 101 and graph 102 may have different schemas, and the entities A, B, C, D of graph 101 may be equivalent to the entities A′, B′, C′, D′ of graph 102, respectively. Entity alignment aims to identify entities from different graphs that refer to the same real-world entity. For example, the entity A of graph 101 may have a name of “Mathematics”, and the entity A′ equivalent to the entity A of graph 102 may have a different name of “Math”.

Generally, a KG may be defined as a graph G={E, R, T}, where e∈E, r∈R, t∈T denote an entity, a relation and a triple, respectively. Given two KGs, G₁={E₁, R₁, T₁} and G₂={E₂, R₂, T₂}, the set of the already aligned entity pairs may be defined as S={(eᵢ, eⱼ)|eᵢ∈E₁, eⱼ∈E₂, eᵢ⇔eⱼ}, where ⇔ represents equivalence.

Entity alignment task is to discover the unique equivalent entities in KG₂ for entities in KG₁. In the deep representation learning era, a neural network f may be trained to encode e∈E into vectors for alignment. Two different entity alignment settings are as follow according to the proportion of used training dataset:
(Semi-) Supervised setting: part of S is provided as the training date for training f.
Unsupervised & Self-supervised setting: none of S is provided for training f.

Naturally, entities in different knowledge graphs lie in different data spaces, as shown in FIG. 1. The measure of similarity needs to be in the same space. Supervision may be leveraged to align the different spaces. For example, some existing methods train projection matrices to project entities from different embedding spaces into a uni-space, which requires abundant training labels.

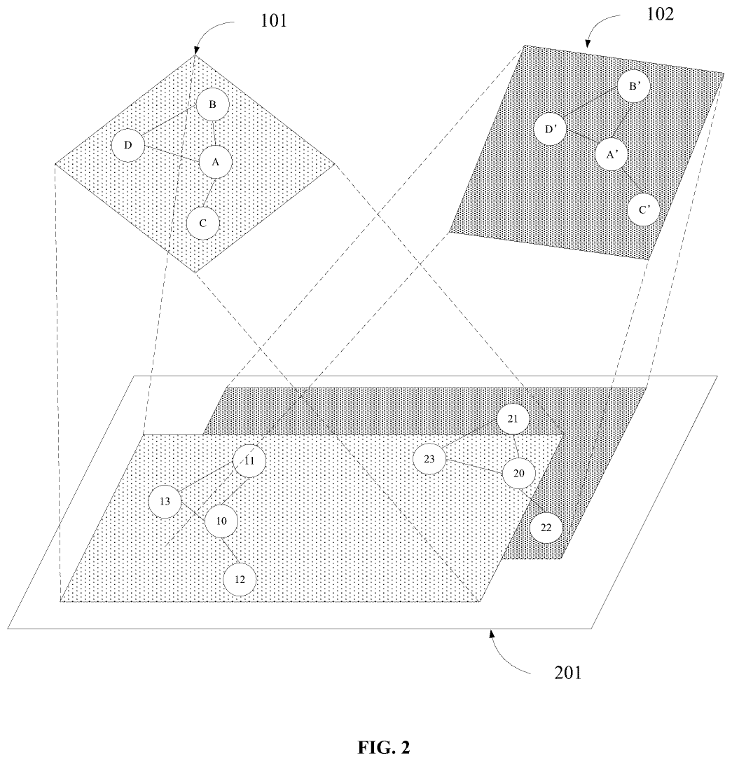

In an aspect of the present disclosure, a uni-space initialization and a shared encoder may be used to avoid supervision. FIG. 2 illustrates an example of uni-space learning according to one or more aspects of the present disclosure. For example, the entities A, B, C, D of the graph 101 and the entities A′, B′, C′, D′ of graph 102 may be encoded by a pre-trained model to obtain corresponding initial embeddings 10, 11, 12, 13, 20, 21, 22, 23 that are in the same or unified space 201. As an example, in terms of multi-lingual datasets (e.g., DBP15K), the pre-trained model shared between the graph 101 and graph 102 may comprise a pre-trained language model, such as LaBSE (Language-agnostic BERT (Bidirectional Encoder Representations from Transformers) Sentence Embedding), or multi-lingual BERT or the like, which has been trained on different languages.

It will be appreciated by those skilled that other pre-trained models may be possible to embed entities from different graphs into a uni-space.

Existing (e.g., supervised, semi-supervised, and/or self-supervised) approaches for entity alignment generally focus on or relate to pulling each pair of positive (i.e., aligned) entities close to each other. Supervision may need to be used to label pairs of positive (i.e., aligned) entities. Alternatively, for example, it may be assumed in a self-supervised learning that the pairs of positive (i.e., aligned) entities may be obtained by taking two independently randomly augmented versions of the same sample, e.g., two crops of the same image.

In an aspect of the present disclosure, only pushing the negatives far away is considered for entity alignment. For example, the present disclosure provides a find that a model learning for entity alignment may benefit more from pushing those randomly sampled (negative) ones far away than pulling aligned (positive) ones close. Therefore, by only pushing the negatives far away enough, the usage of positive data (i.e., labels) can be got rid of while achieving a comparable performance with state-of-the-art supervised baselines.

In representation learning, margin loss or cross-entropy loss have been widely used as similarity metrics. Without loss of generality, these metrics can be expressed in a form of Noise Contrastive Estimation (NCE). Let pₓ,p_{y} be the representation distribution of two knowledge graphs KGₓ,KG_{y}, respectively, pₚₒₛ be the representation distribution of positive pairs (x,y)∈ [symbol] ⁿ× [symbol] ⁿ. Given (x,y)˜pₚₒₛ, {yᵢ⁻}ᵢ₌₁^{M}˜^{i.i.d} p_{y} and encode f satisfies ∥f(·)∥=1, the loss function can be formulated as:

$${ℒ}_{NCE} \hat{=} 𝔼 [ - log \frac{{e}^{{f ( x )}^{T} f ( y ) / τ}}{{e}^{{f ( x )}^{T} f ( y ) / τ} + {\sum }_{i} {e}^{{f ( x )}^{T} f ( {y}_{i}^{-} ) / τ}} ] = - \frac{1}{τ} {f ( x )}^{T} f ( y ) + log ( {e}^{{f ( x )}^{T} f ( y ) / τ} + {\sum }_{i} {e}^{{f ( x )}^{T} f ( {y}_{i}^{-} ) / τ} ) \qquad ( 1 )$$

where τ>0 is a scalar temperature hyperparameter, and the first term of −1/τf(x)^{T}f(y) may pull the positive pair close, and the second term of log(e^{f(x)}^{^{T}}^{f(y)/τ}+Σᵢe^{f(x)}^{^{T}}^{f(y}^{ᵢ}^{^{−}}^{)/τ}) may push negative pairs away.

Generally, the loss [symbol] _{NCE}, for example as formulated by equation (1), may be regarded as an absolute similarity metric (ASM) (i.e., [symbol] _{ASM}). For fixed τ>0, as the number of negative samples M→∞, the (normalized) loss [symbol] _{NCE} converges to its limit with an absolute deviation decaying in [symbol] (M^{-2/3}).

In one or more aspects of the present disclosure, since f(x)^{T}f(y) may be quite large, main challenge may lie in optimizing the second term rather than the first term. Based on the boundedness property of f, an unsupervised upper bound of [symbol] _{ASM} may be obtained. For example, for fixed τ>0 and encode f satisfies ∥f(·)∥=1, a relative similarity metric (RSM) as upper bound for [symbol] _{ASM} may be obtained as follow:

$${ℒ}_{ASM} ≪ {ℒ}_{RSM} = - \frac{1}{τ} + log ( {e}^{1 / τ} + {\sum }_{i} {e}^{{f ( x )}^{T} f ( {y}_{i}^{-} ) / τ} ) ≪ {ℒ}_{ASM} + \frac{1}{τ} [ 1 - {min}_{( x , y ) ∼ {p}_{pos}} ( {f ( x )}^{T} f ( y ) ) ] \qquad ( 2 )$$

In aspects of the present disclosure, by optimizing [symbol] _{RSM} as an upper bound for [symbol] _{ASM}, the aligned ones may be considered as being relatively drawn close by pushing others far away. For example, the RSM may exclude the positive (i.e., aligned) pairs (e.g., without f(x)^{T}f(y)) and may only push the non-aligned entities of x far away.

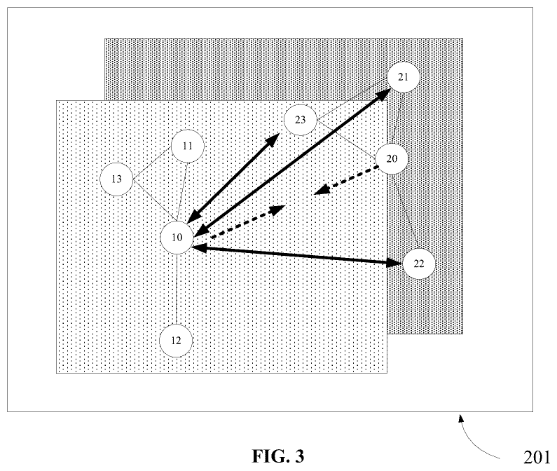

FIG. 3 illustrates a schematic diagram of only pushing the negatives far away according to one or more aspects of the present disclosure. Given the initial embedding 10 of entity A, the RSM may push the corresponding initial embeddings 21, 22, 23 of non-aligned entities B′, C′, D′ away, as indicated by the solid lines, without pulling the corresponding initial embeddings 10 and 20 of the aligned entities A and A′ close, as indicated by the dotted lines. Therefore, only pushing the negatives far away may enable the learning of entity alignment without supervision and may result in a relative proximity of the aligned ones.

In order to obtain negatives, a negative sampling may be performed in the learning. However, it has the possibility for the negative sampling to sample a positive entity without the aid of supervision. Accordingly, for the purpose of avoiding any supervision, the proposed method of entity alignment further samples negatives xᵢ⁻ from KGₓ for x by simply excluding x. Generally, for a given negative sample yᵢ⁻∈KG_{y}, it can be expected there to be some partially similar xᵢ⁻∈KGₓ. Furthermore, the encoder f may be shared across KGₓ and KG_{y}, and to optimize f(xᵢ⁻) will also contribute to the optimization of f(yᵢ⁻).

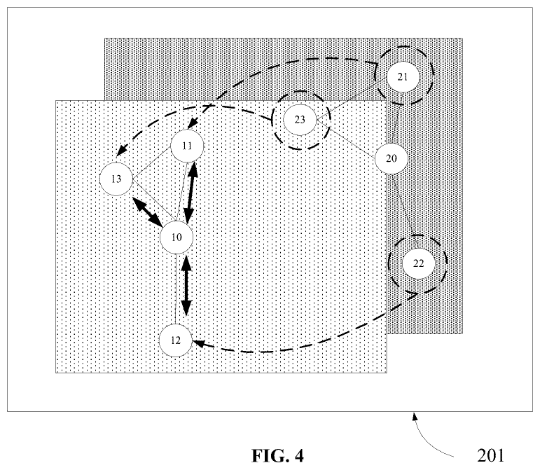

FIG. 4 illustrates a schematic diagram of the self negative sampling according to one or more aspects of the present disclosure. For example, for the given entity A, the negative samples may be changed from initial embeddings 21, 22, 23 of the target graph (e.g., graph 102) to initial embeddings 11, 12, 13 of the source graph (e.g., graph 101). Thus, the self negative sampling may sample negatives for x from KGₓ, to avoid sampling the true target y as a negative.

The effectiveness of the self negative sampling may be justified as below:
Noisy RSM with self negative sampling: let λ be average duplication factor, λ∈ [symbol] ⁺. Let Ωₓ,Ω_{y} be the space of knowledge graph triples, n∈ [symbol] . Let {xᵢ⁻: Ωₓ→ [symbol] ⁿ}ᵢ₌₁^{M}, {yᵢ⁻: Ω_{y}→ [symbol] ⁿ}ᵢ₌₁^{M} be i.i.d random variables with distribution pₓ,p_{y}. [symbol] ^{d-1} denotes a uni-sphere in Rⁿ. If there exists a random variable f: Rⁿ→ [symbol] ^{d-1} s.t. f(xᵢ⁻), f(yᵢ⁻) satisfy the same distribution on [symbol] ^{d-1}, 1≤i≤M. Then it may be obtained as:

$${lim}_{M \to ∞} \vert {ℒ}_{RSM \vert λ , x} ( f ; τ , M , {p}_{x} ) - {ℒ}_{RSM \vert λ , x} ( f ; τ , M , {p}_{y} ) \vert = 0 \qquad ( 3 )$$

It is suggested that under the condition of pₓ=p_{y}, the encoder f can be attained approximately as the minimizer of the uniform loss. Specifically, f may follow the uniform distribution on the hypersphere. In one aspect of the present disclosure, the uni-space learning may ensure to obtain unified representation for both KGs. In other words, the initial embeddings of KGₓ and KG_{y} could be viewed as samples from one single distribution in a larger space, i.e., pₓ=p_{y}. This in turn may allow the existence of f more realizable.

As one example, a joint loss optimizing on both KGₓ and KG_{y} may be used as:

$$ℒ = {ℒ}_{RSM \vert λ , x} ( f ; τ , M , {p}_{x} ) + {ℒ}_{RSM \vert λ , y} ( f ; τ , M , {p}_{y} ) \qquad ( 4 )$$

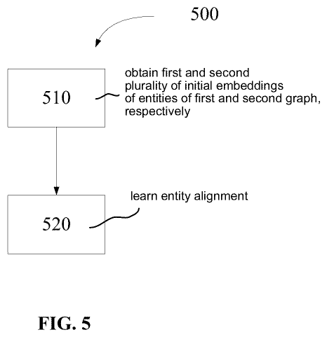

FIG. 5 illustrates a method 500 of entity alignment without supervision according to one or more aspects of the present disclosure discussed above. At block 510, a first plurality of initial embeddings of entities of a first graph and a second plurality of initial embeddings of entities of a second graph may be obtained based on a pre-trained model. For example, the first graph may be a source graph (e.g., graph 101) comprising a given entity (e.g., entity A) for which an equivalent entity may be identified, and the second graph may be a target graph (e.g., graph 102) comprising the equivalent entity (e.g., entity A′). In another example, the first graph may be the target graph and the second graph may be the source graph. The first plurality of initial embeddings and the second plurality of initial embeddings are in a unified space (e.g., unified space 201).

At block 520, entity alignment between the first graph and the second graph may be learned over the first plurality of initial embeddings and the second plurality of initial embeddings by at least one encoder to push non-aligned entities far away using a relative similarity metric. For example, negative sampling for non-aligned entities of an entity of one of the first graph or the second graph may be performed on the one of the first graph or the second graph during the learning. In other words, instead of sampling negatives from the target KG as most baselines do but without labels, which may introduce the true positive ones, the self negative sampling as illustrated by FIG. 4 may be adopted in the method 500.

For example, in terms of lingual datasets (e.g., DBP15K or DWY100K), the pre-trained model embedding both the first graph and the second graph may be a pre-trained language model, such as LaBSE, or multi-lingual BERT or the like, which has been trained on different languages. For another example, in terms of other fields of datasets (e.g., CIFAR-10), other suitable variational autoencoders may be used to embed the first graph and the second graph into a unified space.

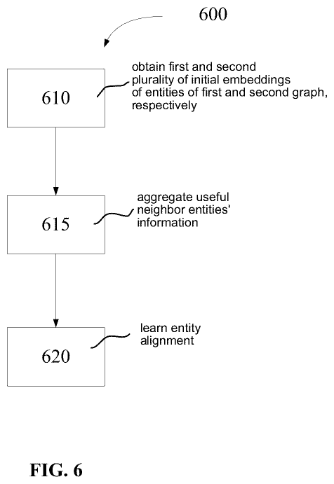

FIG. 6 illustrates another method 600 of entity alignment without supervision according to one or more aspects of the present disclosure discussed above. The processes performed at blocks 610 and 620 of the method 600 may be similar to the processes performed at blocks 510 and 520 of the method 500. At block 615, neighborhood aggregator may be used to aggregate useful neighbor entities' information to the center. For example, a single-head graph attention network (GAT) with one layer may be used to collect pre-trained embedded representations at block 610 to obtain the aggregated initial embeddings for further learning (e.g., by encoder f) at block 620.

For another example, multi-hop neighbors may be considered for the aggregation at block 615. Furthermore, the neighbor entities' information that may be used for aggregation may comprise one or more of neighbor entities' names, structure information, relation information, or neighbor entities' attribution information.

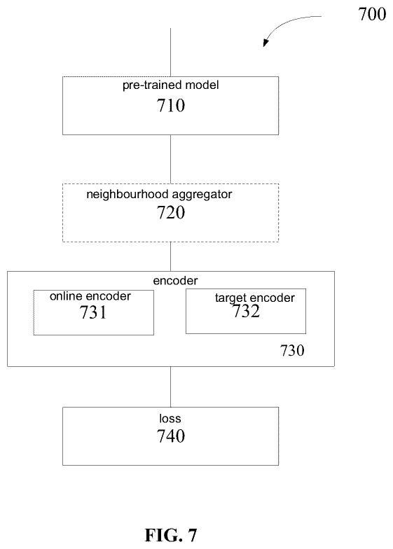

FIG. 7 illustrates an exemplary framework 700 in which the one or more methods proposed herein may be embodied. The framework 700 may comprise a pre-trained model 710, an optional neighbourhood aggregator 720, at least one encoder 730 and a loss 740. For example, the at least one encoder 730 may be shared across different graphs. The loss 740 may have a form of equation (4) and/or equation (2), or other variances thereof.

In one or more aspects of the present disclosure, the neighbourhood aggregator 720 may utilize neighbor entities' information comprising one or more of neighbor entities' names, structure information, relation information, or neighbor entities' attribution information to aggregate useful information to the center. For example, the neighbourhood aggregator 720 may be a single-head GAT with one layer or other networks utilizing multi-hop neighbors.

Considering the error term of contrastive loss decaying with [symbol] (M^{-2/3}) and/or the effectiveness of the self negative sampling justified by equation (3), enlarging the number of negative samples may improve the performance. However, the challenge may lie in time complexity. The time cost of encoding massive negative samples on the fly may be unbearable. In light of this, a negative queue may be utilized to store previous encoded batches by f as the encoded negative samples, which may provide thousands of encoded negative samples at little cost.

In aspects of the present disclosure, respective negative queues may be maintained for each KGs. For example, at the beginning, gradient update may not be implemented until one of the queues reaches a predefined length 1+K, where “1” may indicate the current batch and K may indicate the number of previous batches that may be used as negative samples. Let the number of the entities in a KG be |E|, K and batch size N may be constrained by

$$( 1 + K ) \times N < min ( \vert {E}_{x} \vert , \vert {E}_{y} \vert ) \qquad ( 5 )$$

It may be guarantee by the constraint that the negative sampling would not sample out entities in the current batch. Specifically, the number of negative samples used for each sample of the current batch may be (1+K)×N−1.

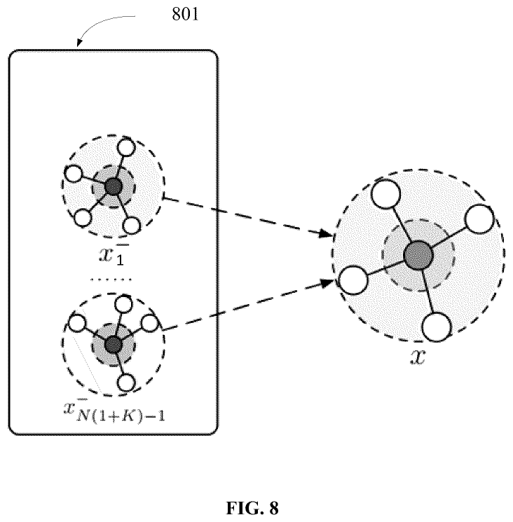

FIG. 8 illustrates a schematic diagram for training depending on a negative queue for each KG to provide massive negative samples (e.g., up to 4000 at a time) to calculate the self-supervised contrastive loss, according to one or more aspects of the present disclosure. For example, the negative queue 801 may be for KGₓ, such as the first graph of the method 500 and/or method 600, and a neighbourhood aggregator (e.g., neighbourhood aggregator 720) may be used to obtain the aggregated initial embeddings of entities of KGₓ, such as x and x₁⁻ . . . x_{(1+K)×N-1}⁻ as indicated by the solid circles. The self-supervised contrastive loss to be calculated based on the given x and its negatives x₁⁻ . . . x_{(1+K)×N-1}⁻ may be based on the first term of the joint loss formulated by equation (4), which may be written as:

$${ℒ}_{RSM \vert x} = - \frac{1}{τ} + log ( {e}^{1 / τ} + {\sum }_{i}^{M} {e}^{{f ( x )}^{T} f ( {y}_{i}^{-} ) / τ} ) \qquad ( 6 )$$

However, the negative queues may comprise obsolete encoded samples, especially for those encoded at the early stage of training when the model parameters may vary drastically. Therefore, the obsolete encoded samples when used as negative samples may harm the training, for example, in an end-to-end training, which only uses one frequently updated encoder.

To mitigate the impact of the obsolete encoded samples, a momentum training strategy may be adopted. In aspects of the present disclosure, two encoders may be maintained. For example, the at least one encoder 730 may comprise an online encoder 731 and a target encoder 732, which are both shared across different graphs, such as the first graph and the second graph of the method 500 and method 600. Parameters of the online encoder 731 may be updated directly with each backpropagation. Parameters of the target encoder 732 may be updated with a momentum m by:

$${θ}_{target} ( n + 1 ) ← m \cdot {θ}_{target} ( n ) + ( 1 - m ) \cdot {θ}_{online} ( n ) , m ∈ [ 0 , 1 ) \qquad ( 7 )$$

where θ_{target}(n) and θₒₙₗᵢₙₑ(n) denote the latest parameters of the target encoder 732 and the online encoder 731, respectively, θ_{target}(n+1) denotes the newly updated parameters of the target encoder 732.

For example, the target encoder 732 with parameters θ_{target}(n) may be used to encode a current batch comprising the initial embeddings of the first graph and the second graph, which may be aggregated with the neighbor entities' information by the neighbourhood aggregator 720. Based on the loss 740, the encoded current batch and the negative queues comprising previously encoded samples, a backpropagation may be performed to update the online encoder 731, resulting in parameters θₒₙₗᵢₙₑ(n) of the online encoder 731. Then, the target encoder 732 may be updated with a momentum m, for example according to the equation (7), to obtain the newly updated parameters θ_{target}(n+1) to be used for encoding a next current batch.

It will be appreciated by those skilled in the art that one or more blocks of FIG. 7 may be omitted or rearranged, and one or more additional blocks may be added depending on a preferable design of a specific application, without causing a departure of the present disclosure.

Owing to the strategies or improvements as discussed above, such as the uni-space learning, only pushing non aligned negatives far away enough, the usage of RSM, and the self negative sampling, the proposed method of entity alignment and/or the framework can scale up to million-scale knowledge graphs. The main challenges of million-scale knowledge graphs may lie in two aspects: supervision and model size. Human supervision can be expensive, especially when the dataset grows tremendously large. For example, the sizes of current entity alignment benchmarks range from several thousand to at most hundred thousand and usually provide 30% of the groundtruth links for training. The proposed method of entity alignment can outperform or match the start-of-art supervised methods without supervision and thus can easily scale to larger KGs. The model size may be another problem, some conventional approach may directly fine-tune a BERT as the backbone whose parameters may be several magnitudes larger than the proposed method of the present disclosure. For the proposed method of entity alignment, fine-tune is not conducted on the pre-trained model, for example, LaBSE, only its outputs (i.e., embeddings) may be used in both training and inference.

It will be appreciated by those skilled in the art that the one or more aspects described with the method 500, method 600 and the framework 700 with reference to FIG. 2 through FIG. 8 may be combined or rearranged, without causing a departure of the disclosure herein.

Exemplary comparisons between the proposed method and the baselines may be given by experiments. For example, for the experiment setup of the proposed method, the batch size is set to 64, momentum m=0.9999, scalar temperature hyperparameter τ=0.08, and the length of the negative queue is set to 64. The experiments are performed at a learning rate of 1e-6 with Adam on an Ubuntu server with NVIDIA V100 GPUs (32G). For all baselines, the reported scores are taken from their original papers and some by BERT-INT (“Bert-int: A bert-based interaction model for knowledge graph alignment.” by X. Tang, J. Zhang, B. Chen, Y. Yang, H. Chen, and C. Li.), CEAFF (“Collective embedding-based entity alignment via adaptive features.” by W. Zeng, X. Zhao, J. Tang, and X. Lin.) and NAEA (“Neighborhood-aware attentional representation for multilingual knowledge graphs.” by Q. Zhu, X. Zhou, J. Wu, J. Tan, and L. Guo.). According to the used proportion of the training labels, all the models to be evaluated may be categorized into two types: 1). supervised: 100% of the aligned entity links in the training set is leveraged; 2). unsupervised or self-supervised: 0% of the training set is leveraged. The performance on DWY100K (comprising two datasets: DWY100Kdbp_wd (DBpedia to Wikidata) and DWY100Kdbp_yg (DBpedia to YAGO3)) is given in Table 1, and performance on DBP15K (comprising three cross-lingual datasets: DBP15K_{zh_en} (Chinese to English), DBP15K_{ja_en} (Japanese to English) and DBP15K_{fr_en} (French to English)) is given in Table 2, where the proposed method may outperform or match most of the evaluated baselines.

TABLE 1
Performance on DWY100K

| | |
|---|---|
| DWY100K_{dbp}_{_{—}}_{wd} | DWY100K_{dbp}_{_{—}}_{yg} |

| | | | | |
|---|---|---|---|---|
| Model | Hit@1 | Hit@10 | Hit@1 | Hit@10 |

Supervised

| | | | | |
|---|---|---|---|---|
| MTransE | 0.281 | 0.520 | 0.252 | 0.493 |
| JAPE | 0.318 | 0.589 | 0.236 | 0.484 |
| IPTransE | 0.349 | 0.638 | 0.297 | 0.558 |
| GCN-Align | 0.477 | — | 0.601 | — |
| MuGNN | 0.616 | 0.897 | 0.741 | 0.937 |
| RSNs | 0.656 | — | 0.711 | — |
| BootEA | 0.748 | 0.898 | 0.761 | 0.894 |
| NAEA | 0.767 | 0.918 | 0.779 | 0.913 |
| TransEdge | 0.788 | 0.938 | 0.792 | 0.936 |
| RDGCN | 0.902 | — | 0.864 | — |
| COTSAE | 0.927 | 0.979 | 0.944 | 0.987 |
| BERT-INT | 0.992 | — | 0.999 | — |
| CEAFF | 1.000 | — | 1.000 | — |

Unsupervised or Self-supervised

| | | | | |
|---|---|---|---|---|
| MultiKE | 0.915 | — | 0.880 | — |
| proposed | 0.983 | 0.998 | 1.000 | 1.000 |
| method (e.g., | | | | |
| method 600) | | | | |

TABLE 2
Performance on DBP15K

| | DBP15K_{zh}_{_{—}}ₑₙ | | DBP15Kⱼₐ_{_{—}}ₑₙ | | DBP15K_{fr}_{_{—}}ₑₙ | | macro |
|---|---|---|---|---|---|---|---|
| Model | Hit@1 | Hit@10 | Hit@1 | Hit@10 | Hit@1 | Hit@10 | Hit@1 |

Supervised

| | | | | | | | |
|---|---|---|---|---|---|---|---|
| MTransE | 0.308 | 0.614 | 0.279 | 0.575 | 0.244 | 0.556 | 0.277 |
| JAPE | 0.412 | 0.745 | 0.363 | 0.685 | 0.324 | 0.667 | 0.366 |
| IPTransE | 0.406 | 0.735 | 0.367 | 0.693 | 0.333 | 0.685 | 0.369 |
| GCN-Align | 0.413 | 0.744 | 0.399 | 0.745 | 0.373 | 0.745 | 0.395 |
| SEA | 0.424 | 0.796 | 0.385 | 0.783 | 0.4 | 0.797 | 0.403 |
| KECG | 0.478 | 0.835 | 0.49 | 0.844 | 0.486 | 0.851 | 0.485 |
| MuGNN | 0.494 | 0.844 | 0.501 | 0.857 | 0.495 | 0.87 | 0.497 |
| RSNs | 0.508 | 0.745 | 0.507 | 0.737 | 0.516 | 0.768 | 0.51 |
| AliNet | 0.539 | 0.826 | 0.549 | 0.831 | 0.552 | 0.852 | 0.547 |
| BootEA | 0.629 | 0.848 | 0.622 | 0.854 | 0.653 | 0.874 | 0.635 |
| NAEA | 0.65 | 0.867 | 0.641 | 0.873 | 0.673 | 0.894 | 0.655 |
| MRPEA | 0.681 | 0.867 | 0.655 | 0.859 | 0.677 | 0.89 | 0.671 |
| JarKA | 0.706 | 0.878 | 0.646 | 0.855 | 0.704 | 0.888 | 0.685 |
| TransEdge | 0.735 | 0.919 | 0.719 | 0.932 | 0.71 | 0.941 | 0.721 |
| GM-Align | 0.679 | 0.785 | 0.740 | 0.872 | 0.894 | 0.952 | 0.771 |

Unsupervised or Self-supervised

| | | | | | | | |
|---|---|---|---|---|---|---|---|
| MultiKE | 0.509 | 0.576 | 0.393 | 0.489 | 0.639 | 0.712 | 0.514 |
| proposed | 0.745 | 0.866 | 0.816 | 0.913 | 0.957 | 0.992 | 0.84 |
| method (e.g., | | | | | | | |
| method 600) | | | | | | | |

In one or more aspects of the present disclosure, the relative similarity metric may exclude aligned entities or positive pairs and implement a relative proximity of the aligned ones by only pushing negatives far away, to avoid label or supervision.

In one or more aspects of the present disclosure, respective negative queues may be maintained for each of the first graph and the second graph during the learning. Each of the respective negative queues may comprise previously encoded batches as negative samples. For example, for a given sample of a current batch, samples of multiple previously encoded batches and the current batch other than the given sample may be served as negatives for the given sample.

In one or more aspects of the present disclosure, the at least one encoder may comprise an online encoder and a target encoder that is used for encoding a current batch, and wherein the online encoder may be updated directly with each backpropagation and the target encoder may be updated with a momentum. For example, the momentum may be set with a relatively large value, for example, 0.9999, to achieve a steady learning and to avoid representation collapse. The online encoder and the target encoder may both be shared across the first graph and the second graph between which two equivalent entities to be identified.

In aspects of the present disclosure, the proposed methods may automatically align entities without a manual label or supervision.

In one or more aspects of the present disclosure, the first plurality of initial embeddings and the second plurality of initial embeddings of entities of the first graph and the second graph may be obtained further through aggregating information of neighbor entities. The information of neighbor entities may comprise one or more of neighbor entities' names, structure information, relation information, or neighbor entities' attribution information.

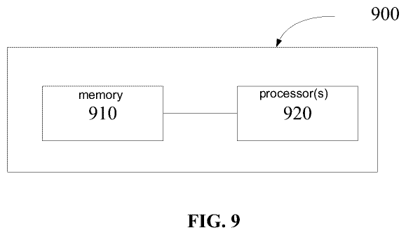

FIG. 9 illustrates an example of a hardware implementation for an apparatus 900 according to one or more aspects of the present disclosure. The apparatus 900 for entity alignment may comprise a memory 910 and at least one processor 920. The processor 920 may be coupled to the memory 910 and configured to perform the method 500, method 600, and to implement the framework 700 described above with reference to FIG. 2 through FIG. 8. The processor 920 may be a general-purpose processor, or may also be implemented as a combination of computing devices, e.g., a combination of a DSP and a microprocessor, multiple microprocessors, one or more microprocessors in conjunction with a DSP core, or any other such configuration. The memory 910 may store the input data, output data, data generated by processor 920, and/or instructions executed by processor 920.

The various operations, models, and networks described in connection with the disclosure herein may be implemented in hardware, software executed by a processor, firmware, or any combination thereof. According one or more aspects of the present disclosure, a computer program product for entity alignment may comprise processor executable computer code for performing the method 500 and method 600 described above with reference to FIG. 2 through FIG. 8. According to one or more aspects of the present disclosure, a computer readable medium may store computer code for entity alignment, the computer code when executed by a processor may cause the processor to perform the method 500 and method 600 described above with reference to FIG. 2 through FIG. 8. Computer-readable media includes both non-transitory computer storage media and communication media including any medium that facilitates transfer of a computer program from one place to another. Any connection may be properly termed as a computer-readable medium. Other embodiments and implementations are within the scope of the disclosure.

The preceding description is provided to enable any person skilled in the art to make or use various embodiments according to one or more aspects of the present invention. Various modifications to these embodiments will be readily apparent to those skilled in the art, and the generic principles defined herein may be applied to other embodiments without departing from the scope of the various embodiments.

1-11. (canceled)

12. A computer-implemented method for entity alignment, the method comprising the following steps:
obtaining a first plurality of initial embeddings of entities of a first graph and a second plurality of initial embeddings of entities of a second graph based on a pre-trained model, wherein the first plurality of initial embeddings and the second plurality of initial embeddings are in a unified space; and
learning entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

13. The computer-implemented method of claim 12, wherein the relative similarity metric excludes aligned entities or positive pairs.

14. The computer-implemented method of claim 12, further comprising:
maintaining respective negative queues for each of the first graph and the second graph during the learning, wherein the respective negative queues include previously encoded batches as negative samples.

15. The computer-implemented method of claim 14, wherein the at least one encoder includes an online encoder and a target encoder that is used for encoding a current batch, and wherein the online encoder is updated directly with backpropagation and the target encoder is updated with a momentum.

16. The computer-implemented method of claim 12, wherein the at least one encoder is shared between the first graph and the second graph.

17. The computer-implemented method of claim 12, further comprising automatically aligning entities without a training label or supervision.

18. The computer-implemented method of claim 12, wherein the obtaining of the first plurality of initial embeddings and the second plurality of initial embeddings further includes aggregating information of neighbor entities.

19. A computer-implemented method for entity alignment of graphs with natural languages, comprising the following steps:
obtaining a first plurality of initial embeddings of entities of a first graph and a second plurality of initial embeddings of entities of a second graph based on a pre-trained language model, wherein the first graph and the second graph include the same or different languages, and the first plurality of initial embeddings and the second plurality of initial embeddings are in a unified space; and
learning entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

20. An apparatus for entity alignment, comprising:
a memory; and
at least one processor coupled to the memory and configured for entity alignment, the at least one processor configured to:
obtain a first plurality of initial embeddings of entities of a first graph and a second plurality of initial embeddings of entities of a second graph based on a pre-trained model, wherein the first plurality of initial embeddings and the second plurality of initial embeddings are in a unified space; and
learn entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.

21. A non-transitory computer readable medium on which is stored computer code for entity alignment, the computer code when executed by a processor, causing the processor to perform the following steps:
obtaining a first plurality of initial embeddings of entities of a first graph and a second plurality of initial embeddings of entities of a second graph based on a pre-trained model, wherein the first plurality of initial embeddings and the second plurality of initial embeddings are in a unified space; and
learning entity alignment between the first graph and the second graph over the first plurality of initial embeddings and the second plurality of initial embeddings by at least one encoder to push non-aligned entities far away using a relative similarity metric, wherein negative sampling for non-aligned entities of an entity of one of the first graph or the second graph is performed on the one of the first graph or the second graph during the learning.
